(19) United States
(12) Patent Application Publication
(10) Pub. No.: US 2014/0217850 A1
(43) Pub. Date: Aug. 7, 2014

(54) ROTOR OF SUPERCONDUCTING ROTATING MACHINES

(71) Applicants: Hyun-Jang Shin, Yongin-si (KR); Byung-San Baek, Suwon-si (KR); Keun-Woong Kim, Yongin-si (KR)

(72) Inventors: Hyun-Jang Shin, Yongin-si (KR); Byung-San Baek, Suwon-si (KR); Keun-Woong Kim, Yongin-si (KR)

(73) Assignee: HYUNDAI HEAVY INDUSTRIES CO., LTD., Ulsan (KR)

(21) Appl. No.: 14/128,076

(22) PCT Filed: Jun. 26, 2012
(86) PCT No.: PCT/KR2012/005024

§ 371 Date: Dec. 20, 2013

(30) Foreign Application Priority Data
Oct. 13, 2011 (KR) 10-2011-0104849

(51) Int. Cl. H02K 55/00

(52) U.S. Cl. CPC H02K 55/00
USPC 310/210

(57) ABSTRACT

A rotor of superconducting rotating machines according to the present invention comprises: a yoke provided with receiving sections which are consecutively formed on the outer peripheral surface thereof; bobbins received in each of the receiving sections of the yoke; and a superconducting coil coupled with the bobbins, wherein interval-maintaining members are formed of high tenacity fibers and coupled between the yoke and the bobbins such that the bobbins are supported at an interval from the inner surfaces of the receiving sections to the bottom surfaces thereof.

### TECHNICAL FIELD

The present invention relates to superconducting rotating machines, and more particularly, to a rotor of superconducting rotating machines, which can block heat penetration to a superconducting coil by conduction, whereby the superconducting coil can be consistently maintained in a cryogenic state.

### BACKGROUND ART

Superconductivity is a phenomenon that, when a metallic material is cooled nearly to 0K (K is the unit of absolute temperature, Kelvin (K), 0 K=−273 degrees Celsius), its electrical resistance is lost completely.

Therefore, if a superconductor having the superconductivity is applied to an electric device, it is possible to prevent a loss of power, because the superconductor has no electrical resistance.

Meanwhile, as an electric device using the superconductivity, there are superconducting rotating machines such as a superconducting motor and a superconducting generator.

In the superconducting rotating machines, since a superconducting coil is provided at a rotor and thus electrical resistance is lost by the superconducting phenomenon, it is possible to minimize the power loss.

If the rotor is continuously rotated in the superconducting rotating machines, mechanical energy of a driving part is consumed as joule's heat due to an eddy current generated in a conductor, and thus heat is generated.

At this time, the heat generated in the rotor of the superconducting rotating machines is transferred to the superconducting coil, and it is difficult to maintain a cryogenic state for embodying the superconducting phenomenon. As a result, efficiency of the superconducting rotating machines is deteriorated.

For this reason, in the corresponding field, developments of a technique for blocking heat penetration to the superconducting coil used in the rotor of the superconducting rotating machines have been attempted. And as one of the results, there was proposed a method of preventing heat penetration to the superconducting coil using a radiation shield.

In the technique, i.e., the method of preventing heat penetration to the superconducting coil using a radiation shield, the heat penetration to the superconducting coil could be blocked only partially. That is, since it was possible to block only the heat penetration caused by radiation but it was not possible to block the heat penetration caused by conduction, the effect of blocking the heat penetration to the superconducting coil fell short of its expectations.

For this reason, in the corresponding field, developments of a new rotor for the superconducting rotating machines, which could block the heat penetration caused by the conduction, have been attempted, but it has not been possible so far to obtain satisfactory results.

### DISCLOSURE

### Technical Problem

The present invention is directed to providing a rotor of superconducting rotating machines, which can block heat penetration to a superconducting coil by conduction during its operation, whereby the superconducting coil can be consistently maintained in a cryogenic state.

### Technical Solution

One aspect of the present invention provides a rotor of superconducting rotating machines, including: a yoke provided with receiving sections which are consecutively formed on an outer circumferential surface thereof; a bobbin received in each of the receiving sections of the yoke; and a superconducting coil coupled with the bobbin, wherein an interval-maintaining member formed of high strength fibers is coupled between the yoke and the bobbin such that the bobbin is supported to be spaced apart from inner and bottom surfaces of the receiving sections.

The receiving sections of the yoke may be formed into grooves which are more depressed than other sections.

A protrusion may be formed on an upper surface of the bobbin.

The interval-maintaining member may be coupled between every inner surface of the receiving sections of the yoke and every outer surface of the bobbin.

The high strength fibers forming the interval-maintaining member may be Kevlar.

### Advantageous Effects

Since the rotor of the superconducting rotating machines according to the present invention is disposed at the bobbin supported by the interval-maintaining member formed of the high strength fibers, heat from the yoke is prevented from being transferred to the bobbin through thermal conduction by the material properties of the interval-maintaining member having extremely low thermal conductivity, and thus the superconducting coil can be consistently maintained in a cryogenic state.

### DESCRIPTION OF DRAWINGS

FIG. 1 is a perspective view illustrating an external shape of a rotor of superconducting rotating machines according to the present invention.

FIG. 2 is a cross-sectional view illustrating the structure of the rotor of the superconducting rotating machines according to the present invention.

FIG. 3 is an exploded perspective view illustrating a state of supporting a bobbin through an interval-maintaining member in the rotor of the superconducting rotating machines according to the present invention.

### MODES OF THE INVENTION

Hereinafter, exemplary embodiments of the present invention will be described in detail with reference to the accompanying drawings.

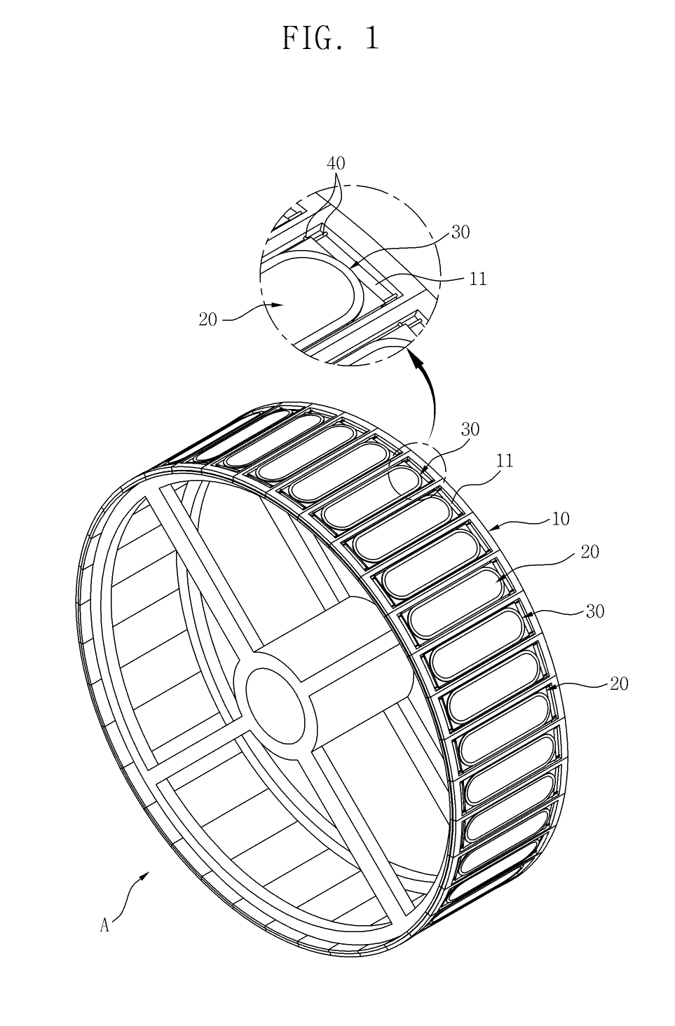

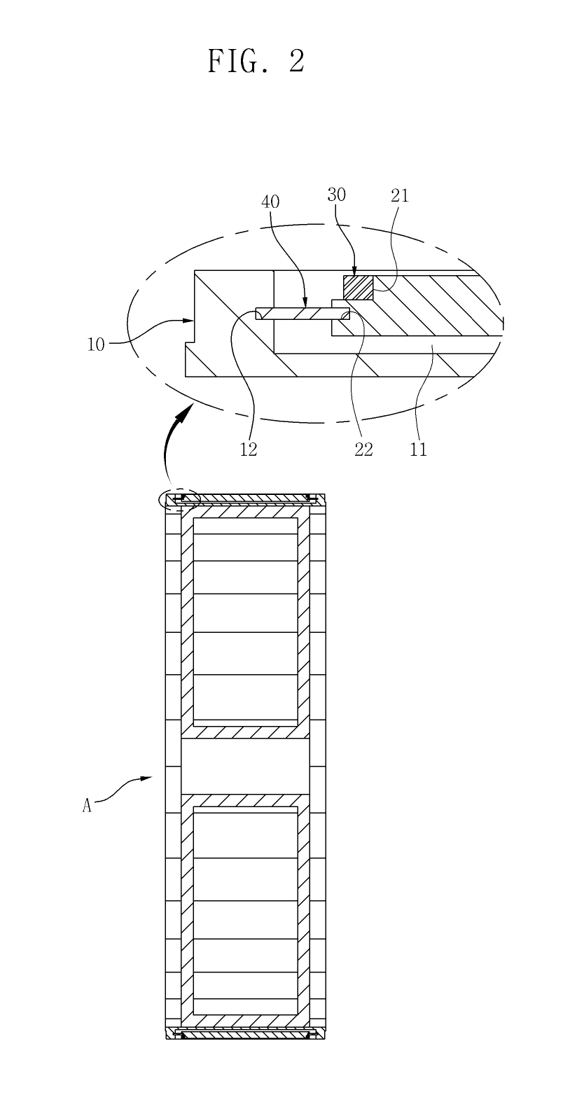

As shown in FIGS. 1 and 2, a rotor A of superconducting rotating machines includes a yoke 10, a bobbin 20, a superconducting coil 30, and an interval-maintaining member 40.

The yoke 10 is provided with receiving sections 11 which are consecutively formed on an outer circumferential surface thereof.

Preferably, the receiving sections 11 of the yoke 10 are formed into grooves which are more depressed than other sections.

Since the receiving sections 11 of the yoke 10 are formed into grooves more depressed than other sections, the receiving sections form each space having a predetermined height and receive the bobbin 20.

The bobbin 20 can be received in each receiving section 11.

Preferably, a protrusion 21 is formed on an upper surface of the bobbin 20.

Since the protrusion 21 is formed on the upper surface of the bobbin 20 so that the superconducting coil 30 is inserted onto the outer circumference of the protrusion 21, the superconducting coil 30 can be facilely coupled with the bobbin 20.

The superconducting coil 30 is coupled to the bobbin 20.

As described above, since the superconducting coil 30 may be formed of any typical superconducting materials, description thereof will be omitted.

The interval-maintaining member 40 is interposed between the yoke 10 and the bobbin 20, and formed of high strength fibers.

Preferably, when the interval-maintaining member 40 is interposed between the yoke 10 and the bobbin 20, the interval-maintaining member 40 is disposed between every inner surface of the receiving sections 11 of the yoke 10 and every outer surface of the bobbin 20.

Since the interval-maintaining member 40 is interposed between every inner surface of the receiving sections 11 of the yoke 10 and every outer surface of the bobbin 20, the bobbin 20 can be supported in a state of being spaced apart from inner and bottom surfaces of the receiving sections 11.

At this time, holes 12 and 22 are formed in each of the inner surfaces of the receiving sections 11 and the outer surfaces of the bobbin 20, and both ends of the interval-maintaining member 40 are inserted into the holes 12 and 22, thereby coupling the interval-maintaining member 40.

Meanwhile, the interval-maintaining member 40 may be formed of any high strength fibers, for example, Kevlar.

Here, since the Kevlar has a tensile strength greater than that of steel and a thermal conductivity of 0.04, which is 1500 times lower than that of steel, the bobbin 20 can be firmly supported, and while the bobbin 20 is supported, heat conduction from the yoke 10 can be also blocked.

Hereinafter, in the rotor A of the superconducting rotating machines according to the present invention as described above, a method of maintaining the superconducting coil 30 in a cryogenic state will be described.

In the present invention, the superconducting coil 30 is coupled to the upper surface of the bobbin 20.

And the bobbin 20 is received in each receiving section 11 of the yoke 10.

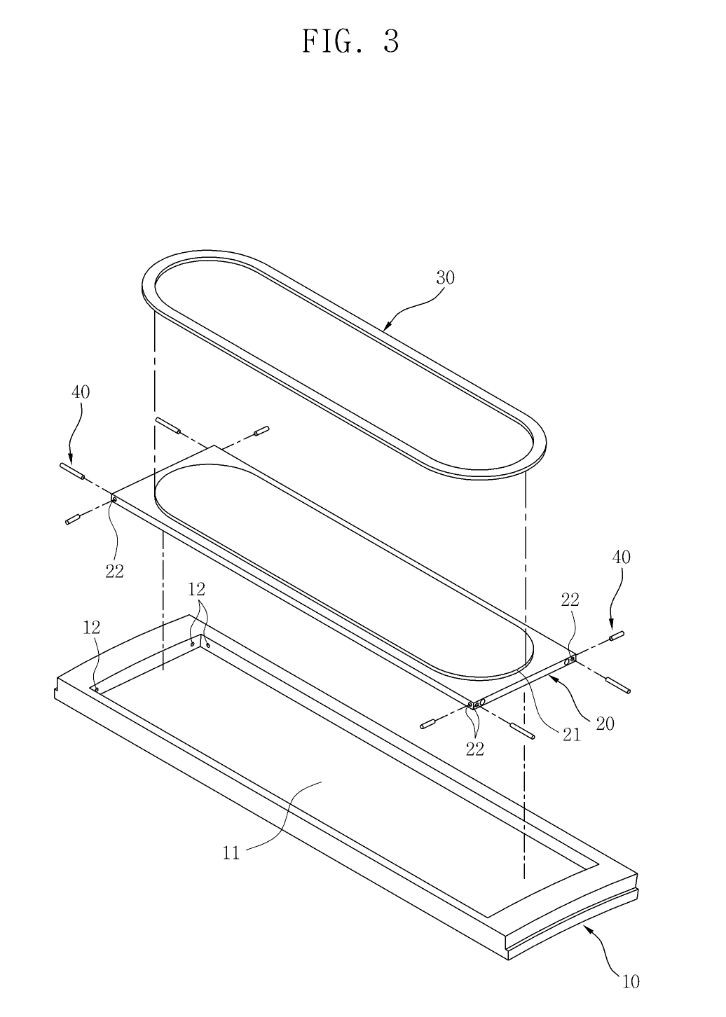

And as shown in FIG. 3, the bobbin 20 received in each receiving section 11 of the yoke 10 is supported to be spaced apart from the inner and bottom surfaces of the receiving sections 11 by the interval-maintaining member 40 interposed between every inner surface of the receiving sections 11 of the yoke 10 and every outer surface of the bobbin 20.

Meanwhile, during operation of the superconducting rotor (not shown), heat is generated from the yoke 10.

At this time, the heat from the yoke 10 may be transferred to the bobbin 20 by conduction and thus penetrated to the superconducting coil 30.

However, in the present invention, since the bobbin 20 is spaced apart from the inner and bottom surfaces of the receiving sections 11 of the yoke 10 by the interval-maintaining member 40 and the yoke 10 and bobbin 20 are connected through only the interval-maintaining member 40, the heat from the yoke 10 is prevented from being transferred to the bobbin 20 due to properties of the interval-maintaining member 40 formed of the high strength fibers having extremely low thermal conductivity, and thus the heat penetration to the superconducting coil 30 by thermal conduction can be blocked. Therefore, the superconducting coil 30 disposed on the bobbin 20 can be consistently maintained in an initial cryogenic state.

As described above, since the rotor A of the superconducting rotating machines according to the present invention is disposed at the bobbin 20 supported by the interval-maintaining member 40 formed of the high strength fibers, the heat from the yoke 10 is prevented from being transferred to the bobbin 20 through thermal conduction by the material properties of the interval-maintaining member 40 having the extremely low thermal conductivity, and thus the heat penetration to the superconducting coil 30 by thermal conduction can be blocked. Therefore, the superconducting coil 30 can be consistently maintained in a cryogenic state.

While the present invention has been described in detail, it should be understood that various changes, substitutions, and alterations can be made hereto without departing from the spirit and scope of the invention as defined by the appended claims.

### INDUSTRIAL APPLICABILITY

The present invention can efficiently applied to a rotor of a superconducting rotating machines, in which heat penetration to a superconducting coil caused by conduction during operation can be blocked, whereby the superconducting coil can be consistently maintained in a cryogenic state.

1. A rotor of superconducting rotating machines, comprising:
a yoke provided with receiving sections which are consecutively formed on an outer circumferential surface thereof;
a bobbin received in each of the receiving sections of the yoke; and
a superconducting coil coupled with the bobbin,
wherein an interval-maintaining member formed of high strength fibers is coupled between the yoke and the bobbin such that the bobbin is supported to be spaced apart from inner and bottom surfaces of the receiving sections.

2. The rotor of claim 1, wherein the receiving sections of the yoke are formed into grooves which are more depressed than other sections.

3. The rotor of claim 1, wherein a protrusion is formed on an upper surface of the bobbin.

4. The rotor of claim 1, wherein the interval-maintaining member is coupled between every inner surface of the receiving sections of the yoke and every outer surface of the bobbin.

5. The rotor of claim 4, wherein the high strength fibers forming the interval-maintaining member are Kevlar.
